(19) United States
(12) Patent Application Publication
(10) Pub. No.: US 2002/0008076 A1
(43) Pub. Date: Jan. 24, 2002

(54) Synthetic closure for bottles

(76) Inventor: Daniel R. Bartholomew, Knightdale, NC (US)

Correspondence Address: Melvin I. Stoltz, Esq., 51 Cherry Street, Milford, CT, 06460, US

(21) Appl. No.: 09/874,819

(22) Filed: Jun. 5, 2001

Related U.S. Application Data
(60) Provisional application No. 60/212,478, filed on Jun. 16, 2000.

(51) Int. Cl. B65D 39/00; B29C 47/00

(52) U.S. Cl. 215/355; 264/45.9; 264/148

(57) ABSTRACT

It has been discovered that the presence of an antioxidant in a closure or stopper, particularly in a synthetic closure or stopper, used to seal liquid products in a container causes excessive extraction forces to be required to remove the closure/stopper from the container. In particular, in sealing wine in a wine bottle, wherein the closure/stopper remains in the bottle for extended periods of time, the presence of the antioxidant causes increased extraction forces to be required. In accordance with the present invention, by reducing and controlling the amount of antioxidant employed in forming the closure/stopper, excessive extraction forces are controlled and remain at normal levels.

### TECHNICAL FIELD

This invention relates to closures or stoppers for containers and, more particularly, to closures or stoppers which remain removable from the container without excessive force, regardless of the time period within which the closure/stopper has been in the container.

### BACKGROUND ART

A wide variety of different products are commonly sold in containers, particularly containers with round necks which define the dispensing portal. In this regard, numerous constructions have been created for closing the dispensing portal. In particular, products such as vinegar, vegetable oils, laboratory liquids, detergents, honey, condiments, spices, alcoholic beverages, and the like, impose similar requirements on the type and construction of the closure means being used for the containers within which these products are retained.

One product which imposes the most demanding requirements on a bottle closure is wine, due to the unique sealing requirements needed for preserving and maintaining the flavor of the wine while stored in the bottle. Presently, wine bottle closures or stoppers are constructed from cork or from synthetic plastic materials.

Although cork, which is a natural product, has been widely used as the source for most wine bottle closures, cork material is a limited resource which is becoming increasingly difficult to harvest in sufficient quantities to meet the ever growing demands. Furthermore, irregularities in the cork's structure due to geographic, climate, and ecological reasons, cause many quality grades to exist in the harvested product. This creates a complex categorization of qualities and standards. In addition, it is estimated that 1% to 5% of all bottled wine is spoiled by cork taint.

Another problem commonly found with natural cork is leaking bottles. Typically, the lack of tightness between the cork and the neck of the bottle causes 10% to 20% of bottle leakage. However, the majority of wine leakage is caused by passage of the wine through the cork's body. These problems are most often found with lower quality cork material, which is typically porous, too soft, out of round, or out of the established specifications.

In order to avoid some of the difficulties encountered with the use of cork closures, bottlers have developed various coatings, such as paraffins, silicones, and polymer materials, in an attempt to ease the movement of the cork into and out of the bottle, as well as to improve the permeability of the cork and fill imperfections in the cork surface. However, no ideal cork coating product has been developed to protect a wine corking member from all of the inherent difficulties or drawbacks of the material.

The majority of wine containing bottles are currently being sold with natural cork stoppers. However, due to the inherent problems existing with natural cork, other products have been developed to seal liquid bearing containers, such as wine bottles. The principal alternate material presently being employed for sealing wine bottles comprises synthetic plastic material, typically a thermoplastic material. In addition, due to the increasing difficulties and quality control problems inherent with cork material, wine bottlers are employing closures formed of synthetic plastic material in ever increasing quantities.

Regardless of the material employed for forming closures or stoppers for wine bottles, one of the principal difficulties to which any bottle closure is subjected is the manner in which the closure is inserted into the wine bottle. Typically, the closure is placed in a jaw clamping member positioned above the bottle portal. The clamping member incorporates a plurality of separate and independent jaw members which peripherally surround the closure member and are movable relative to each other to compress the closure member to a diameter substantially less than its original diameter. Once the closure member has been fully compressed, a plunger moves the closure means from the jaws directly into the neck of the bottle, wherein the closure member expands into engagement with the interior diameter of the bottle neck and portal, thereby sealing the bottle and the contents thereof.

During the process of inserting the closure into the portal of the wine bottle, it has been found that a friction reducing coating usually must be applied to the outer surface of the closure or stopper in order to enable the stopper to be fully inserted into the neck of the bottle. Typically, if a friction reducing coating is not applied to the surface of the closure or stopper, the stopper expands immediately upon exiting the jaws and frictionally engages the surface of the bottle neck prior to being completely inserted into the wine bottle.

In most applications, the friction reducing coating comprises one selected from the group consisting of paraffins, silicones, and other similar compositions which provide the desired friction reduction to the surface of the closure, while also being capable of being easily applied and retained on the outer surface of the closure. In addition, regardless of the composition of the wine bottle closure or stopper, the use of a friction reducing material is generally required.

Another problem which is unique to the wine industry and requires the bottle closure or stopper to possess specific physical characteristics is the method by which the bottle or stopper is removed from the wine bottle. In this regard, cork screws are typically advanced into the stopper and, force is applied to withdraw the stopper from the bottle. Since manual force is typically used during this removal process, the frictional engagement between the stopper and the neck of the bottle must be maintained at a level which will allow most individuals to be capable of removing the stopper from the wine bottle without using excessive force or strength.

In addition, a careful balance must be maintained between the requirements imposed upon the bottle stopper or closure for low frictional engagement with the walls of the bottle during the insertion process as well as the removal process and the requirement that high frictional engagement be maintained to withstand the substantial pressure buildup that occurs during the storage of the wine in the bottle after the wine has been sealed therein. Due to the natural expansion of the wine during hotter months, pressure builds up, imposing a burden on the bottle stopper that must be resisted without allowing the stopper to be displaced from the bottle. As a result, the bottle stopper employed for wine products must be capable of secure, intimate, frictional engagement with the bottle's neck in order to resist any such pressure buildup.

Recently, with the increasing acceptance and use of wine bottle stoppers or closures formed from synthetic plastic materials, it has been found that removal of the stopper from the bottle requires excessive force to be applied to the stopper before removal of the stopper can be realized. In order to eliminate this problem, extensive efforts have been expended to determine the cause of this increased frictional engagement and solutions for eliminating the problem. However, no satisfactory resolution has been attained.

Therefore, it is a principal object of the present invention to provide a closure or stopper for liquid bearing containers, particularly wine bottles, which completely seals the product within the container while also being easily removed from the container without requiring excessive force.

Another object of the present invention is to provide a closure/stopper having the characteristic features described above, which is also capable of being exposed to numerous heat treatment cycles, without incurring any degradation or product changes.

Another object of the present invention is to provide a closure/stopper having the characteristic features described above which prevents leakage of the liquid product from the container, while also preventing unwanted exchange of air or gases.

Another object of the present invention is to provide a synthetic closure/stopper having the characteristic features described above which meets or exceeds all of the requisite physical characteristics found in natural closures/stoppers, such as those formed from cork.

Another object of the present invention is to provide a synthetic closure/stopper having the characteristic features described above which can be mass-produced on a continuing basis and eliminates any spoilage of wine due to cork taint.

Other and more specific objects will in part to be obvious and will in part appear hereinafter.

### DETAILED DISCLOSURE

As the cost and non-predictability of the supply of natural cork has continued to escalate, wine bottlers have increasingly employed synthetic closures as a substitute for cork material. However, as the use of closures or stoppers formed from synthetic plastic material has increased, problem areas have been discovered. One major problem which has baffled the industry is an unexpectedly high increase in the frictional engagement of the stopper with the wine bottle over time, resulting in an increase of the extraction force needed to remove the stopper.

By employing the present invention, all of the difficulties and drawbacks found in the prior art have been eliminated, and a synthetic bottle closure or stopper has been realized which is capable of being inserted into a wine bottle, using normal techniques, with complete assurance that frictional forces between the stopper and the bottle will not increase over time, and only normal removal forces need be used to open the bottle.

Usually, synthetic closures employ a plastic material, typically a thermoplastic which is formed by molding or extrusion. Regardless of the particular plastic material or formulation employed or the manufacturing method employed, it has been found that synthetic closures or stoppers experience an increase in the force required to remove the closure or stopper from the wine bottle. In addition, this increase in the frictional engagement of the stopper with the bottle has been found to be directly proportional to time, starting with the insertion of the stopper in the bottle. Although this phenomenon has been discovered and attempts have been made to eliminate this problem, no realistic or satisfactory method has been achieved to overcome this problem, until the present invention.

After substantial effort, it was discovered that the concentration of the antioxidant in the plastic material was the cause of the increase in the extraction forces required for removing the synthetic closure or stopper from the wine bottle. In addition, it was also discovered that the increase of the extraction force over time was directly proportional to the blooming or migration of the anti-oxidants from the interior of the plastic composition of the stopper to its outer surface.

Normally, plastic polymers are protected from thermal degradation by incorporating antioxidants into the polymer composition. The concentration of the antioxidants employed in any particular formulation is determined by the manufacturer, based upon the number of heat cycles to which the material will be typically exposed, as well as the intended end use for the material. Until the present invention, no specific control or limitations were imposed upon the concentration of the antioxidants in the plastic materials employed for manufacturing wine bottle closures, since the unwanted effects being produced by the antioxidants were unknown.

In accordance with the present invention, it has been discovered that the antioxidants in the plastic material employed for manufacturing closures or stoppers for wine bottles should be maintained at a concentration level which is no greater than 0.28% by weight, based upon the weight of the entire plastic material. By not exceeding this concentration limit, the increase in the extraction forces that are realized when the synthetic closures are removed from wine bottles are maintained at reasonable or manageable levels.

This limitation on the concentration of the antioxidant in the plastic material has been found to be effective in any synthetic closure regardless of the plastic material employed or the method for manufacturing the closure or stopper. Furthermore, it has also been found that this maximum concentration of the antioxidant is applicable to all antioxidants, regardless of manufacturer.

As discussed above, synthetic closures or stoppers have been manufactured using molding equipment or extrusion equipment. However, regardless of the manufacturing method employed, synthetic closures or stoppers incorporating anti-oxidants which are greater than 0.28% by weight based upon the weight of the entire plastic material all suffer with the common problem that the extraction forces required to remove the closure or stopper from the container become excessive with time.

As stated, commercially saleable synthetic closures or stoppers can be manufactured using molding equipment, while also incorporating the teaching of the present invention. However, in the preferred manufacturing method, extrusion equipment is employed. In addition, in using extrusion equipment to produce the synthetic closure, the plastic material employed may be foamed or non-foamed.

In the preferred construction, the synthetic closure or stopper of the present invention is formed as an extruded product using a medium density or low density closed cell plastic material which is foamed during the manufacturing process. However, if a non-foamed product is desired, the same plastic material may be employed. Furthermore, the preferred plastic material comprises one or more plastics selected from the group consisting of inert polymers, homopolymers, and copolymers. In addition, the preferred plastic material is preferably selected from the group consisting of polyethylenes, metallocene catalyst polyethylenes, polybutanes, polybutylenes, polyurethanes, silicones, vinyl based resins, thermoplastic elastomer, polyesters, ethylene acrylic copolymers, ethylene-vinyl-acetate copolymers, ethylene-methyl acrylate copolymers, ethylene-butyl-acrylate copolymers, ethylene-propylene-rubber, styrene butadiene rubber, ethylene-ethyl-acrylic copolymers, ionomers, polypropylenes, and copolymers of polypropylene and copolymerizable ethylenically unsaturated commoners, as well as ethylenic acrylic copolymers, ethylene-vinyl-acetate copolymers, ethylene-methyl-acrylate copolymers, thermoplastic polyurethanes, thermoplastic olefins, thermoplastic vulcanizates, flexible polyolefins, fluorelastomers, fluoropolymers, polyethylenes, teflons, ethylene-butyl-acrylate copolymers, ethylene-propylene-rubber, styrene butadiene rubber, ethylene-ethyl-acrylic copolymers and blends thereof. Furthermore, if a polyethylene is employed, it has been found that the polyethylene may comprise one or more polyethylenes selected from the group consisting of high density, medium density, low density, linear low density, ultra high density, and medium low density.

As is well known in the industry, a blowing agent is employed in forming extruded foam plastic material. In the present invention, a variety of blowing agents can be employed during the extruded foaming process which produces the synthetic closure or stopper. Typically, either physical blowing agents or chemical blowing agents are employed. Suitable blowing agents that have been found to be efficacious in producing the synthetic closure of the present invention comprise one or more selected from the group consisting of: Aliphatic Hydrocarbons having 1-9 carbon atoms, Halogenated Aliphatic Hydrocarbons having 1-9 carbon atoms and Aliphatic alcohols having 1-3 carbon atoms. Aliphatic Hydrocarbons include Methane, Ethane, Propane, n-Butane, Isobutane, n-Pentane, Isopentane, Neopentane, and the like. Among Halogenated Hydrocarbons and Fluorinated Hydrocarbons they include Methylfluoride, Perfluoromethane, ethyl Fluoride, 1,1-Difluoroethane (HFC-152a), 1,1,1-Trifluoroethane (HFC 430a), 1,1,1,2-Tetrafluoroethane (HFC 134a), Pentafluoroethane, Perfluoroethane, 2,2-Difluoropropane, 1,1,1-Trifluoropropane, Perfluoropropane, Perfluorobutane, Perfluorocyclobutane. Partially Hydrogenated Chlorocarbon and Chlorofluorocarbons for use in this invention include Methyl Chloride, Methylene Chloride, Ethyl Chloride, 1,1,1-Trichlorethane, 1,1-Dichloro1-Fluoroethane (HCFC-141 b), 1-Chlorol, 1-Difluoroethane (HCFC142b), 1,1-Dichloro-2,2,2-Trifluoroethane (HCFC-123) and 1-Chloro-1,2,2,2-Tetrafluoroethane (HCFC124). Fully Halogenated Chlorofluorocarbons include Trichloromonofluoromenthane (CFC11), Dichlorodifluoromenthane (CFC12), Trichlorotrifluoroethane (CFC113), Dichlorotetrafluoroethane (CFC114), Chloroheptafluoropropane, and Dichlorohexafluoropropane. Fully Halogenated Chlorofluorocarbons are not preferred due to their ozone depiction potential. Aliphatic alcohols include Methanol, Ethanol, n-Propanol and Isopropanol. Suitable inorganic blowing agent is useful in making the foam of the present invention include carbon dioxide, nitrogen, carbon, water, air, nitrogen, helium, and argon.

Chemical blowing agents include Azodicarbonamic, Azodiisobutyro-Nitride, Benzenesulfonhydrazide, 4,4-Oxybenzene Sulfonylsemicarbazide, p-Toluene Sulfonylsemicarbazide, Barium Azodicarboxlyate, N,N′-Dimethyl-N,N′-Dinitrosoterephthalamide and Trihydrazinotriazine.

Preferably, in order to produce the desired product, the blowing agent is incorporated into the plastic melt in a quantity ranging between about 0.005% to 10% by weight of the weight of the plastic material.

As detailed above, either a physical blowing agent or a chemical blowing agent can be employed as part of the extrusion process for forming the synthetic closure or stopper of the present invention. However, it has been found that the selection of a physical blowing agent is preferred since physical blowing agents allow the synthetic closure to be achieved with a lower density, which is closer to natural cork.

In this regard, a blowing agent which is inert is preferred. Although any desired inert blowing agent may be employed, the blowing agent is preferably selected from the group consisting of nitrogen, carbon dioxides, sulphur dioxide, water, air, nitrogen, helium, and argon. In addition, hydrocarbons can be employed as the blowing agent which are preferably selected from the group consisting of butane, isobutene, pentane, isopentane and propane.

The invention accordingly comprises the several steps and the relation of one or more of such steps with respect to each of the others, and the composition possessing the features, properties, and relation of components, all as exemplified herein, with the scope of the invention being indicated in the claims.

### BEST MODE FOR CARRYING OUT THE INVENTION

In order to substantiate and clearly demonstrate the efficacy of the present invention, the following examples are presented. In this disclosure, the universal applicability of the present invention is fully detailed, with the ability to control extraction forces being achieved by controlling the quantity of the antioxidant used in the synthetic closure composition. However, it is to be understood that the examples provided herein are intended as a teaching of the best mode for carrying out the present invention and are not intended to limit, in any manner, the breath of this discovery.

In order to demonstrate the efficacy of the present invention, plastic material formulations were made for use in manufacturing wine bottle closures or stoppers using four separate and independent concentrations of antioxidants. These four concentration levels consisted of 0.28%, 0.14%, 0.07%, and 0.035%. In each instance, the concentration of the antioxidant was based upon the weight of the antioxidant based upon the weight of the entire plastic material. In addition, each of the four formulations were employed to produce four separate batches of wine bottle closures using the identical manufacturing process. In each instance, the bottle closures were produced using the materials and the extrusion methods defined in U.S. Pat. Nos. 5,904,965, 6,221,450, and 6,221,451.

The antioxidant employed in each of these samples comprised Irganox 1010 which is manufactured by Ciba-Specialty Chemicals Corporation of Tarrytown, N.Y. Although this antioxidant is preferred, in accordance with the present invention, all antioxidants employed in plastic materials used in the production of closures or stoppers for wine bottles should be maintained at the same concentration limitations defined herein.

Once the wine bottle closures were produced using each of the four separate and independent formulations, 50 closures were selected from each batch, were treated in the normal manner and inserted into wine bottles. This manufacturing and bottling process was conducted and completed in a single day.

Thereafter, all of the bottles were stored in the identical manner and several bottles were randomly selected from each batch at different time intervals, ranging from 3 days to 219 days. For each bottle selected, the extraction force required to remove the closure from the bottle was determined and recorded. By referring to Table 1, a comparison of the extraction force required for each formulation at each time interval can readily be seen. In general, the extraction force should preferably be below 100 lbs.

TABLE I
Extraction Force Required Over Time

| | Antioxidant | Antioxidant | Antioxidant | Antioxidant |
|---|---|---|---|---|
| Days | At .035% | At .07% | At .14% | At .28% |
| 3 | 69.3 lbs | 66.2 lbs | 72 lbs | 70.8 lbs |
| 10 | 68.3 lbs | 68.9 lbs | 68.6 lbs | 103.3 lbs |
| 13 | 64.4 lbs | 67.5 lbs | 68.3 lbs | 124.3 lbs |
| 20 | 69.4 lbs | 70 lbs | 74.1 lbs | 152 lbs |
| 30 | 72.2 lbs | 74.7 lbs | 84.5 lbs | 162.5 lbs |
| 45 | 76.5 lbs | 76.3 lbs | 101.9 lbs | 143.2 lbs |
| 60 | 72.7 lbs | 75.1 lbs | 108.5 lbs | 185.2 lbs |
| 95 | 72.3 lbs | 68.5 lbs | 105 lbs | 133.3 lbs |
| 124 | 74.3 lbs | 74.8 lbs | 101.8 lbs | 110 lbs |
| 152 | 74.4 lbs | 78.2 lbs | 98.2 lbs | 136.3 lbs |
| 180 | 73.3 lbs | 71 lbs | 89.5 lbs | 127.1 lbs |
| 219 | 74.1 lbs | 72.5 lbs | 98.4 lbs | 119.9 lbs |

In accordance with the present invention and as clearly demonstrated in the foregoing comparative data, it has been established that the concentration of the antioxidant in the plastic material is a controlling factor in causing the extraction force of the closure or stopper to be increased with time. In addition, by reducing the concentration of the antioxidant to a level which does not exceed 0.28% by weight based upon the weight of the entire plastic composition, the extraction forces are maintained at an acceptable level.

In a separate test, the procedures detailed above were employed in a substantially identical manner using a different antioxidant. In this test program, the antioxidant used was Sandostab P-EPQ, manufactured by Clariant Corporation of Switzerland. The results produced by this test program were substantially identical to the results detailed above. As a result, these tests further confirmed that the concentration of the antioxidant in the closure/stopper of the present invention should be no greater than 0.28% by weight based upon the weight of the entire composition in order to avoid excessive extraction forces to be required.

In addition, it has also been found that additional contributing factors to the increase in the extraction force over time include (1) the friction reducing material employed on the outer surface of the stopper or closure, and (2) the number of times that the stopper or closure is heat treated for enabling the surface thereof to be printed. These additional factors combine with the concentration of the antioxidant to further exacerbate the effect of the antioxidant and the increase in the extraction forces. However, it is believed that the principal factor, namely the concentration of the antioxidant, is the controlling factor which, when limited in accordance with the teaching of the present invention, completely resolves the problems which have plagued manufacturers of synthetic wine closures.

It will thus be seen that the objects set forth above, among those made apparent from the preceding description, are efficiently attained and, since certain changes may be made in the compositions detailed herein, as well as in carrying out the above process, without departing from the scope of the invention, it is intended that all matter contained in the above description shall be interpreted as illustrative and not in a limiting sense.

It is to be understood that the following claims are intended to cover all of the generic and specific features of the invention herein described, and all statements of the scope of the invention which, as a matter of language, might be said to fall therebetween.

Particularly, it is to be understood that in said claims, ingredients and compounds recited in the singular are intended to include compatible mixtures of such ingredients whenever the sense permits.

Having described my invention, what I claim as new and desired to seek Letters Patent is:

1. A method for manufacturing synthetic stoppers or closures for a product retaining container constructed for being inserted and securely retained in a portal forming neck of the container, said process comprising the steps of:
A. selecting at least one plastic polymer as the material for forming the synthetic closures;
B. intermixing an antioxidant with the selected plastic polymer to form a substantially homogeneous mixture;
C. controlling the amount of the antioxidant intermixed with the plastic material to comprise no greater than 0.28% by weight based upon the weight of the entire mixture; and
D. forming a plurality of synthetic closures from the homogeneous mixture;
whereby synthetic closures or stoppers for product retaining containers are achieved, providing a closure which is capable of being extracted from the container without requiring excessive force.

2. The method defined in claim 1, wherein said plastic polymer is further defined as comprising a thermoplastic polymer.

3. The method defined in claim 2, wherein the thermoplastic polymer is further defined as comprising medium density or low density, closed cell, foamed plastic comprising one or more selected from the group consisting of inert polymers, homopolymers, and copolymers.

4. The method defined in claim 3, wherein said closed cell foamed plastic polymer is further defined as comprising at least one selected from the group consisting of polyethyles, metallocene catalyst polyethyles, polybutanes, polybutylenes, polyurethanes, silicones, vinyl-based resins, thermoplastic elastomers, polyesters, ethylenic acrylic copolymers, ethylene-vinyl-acetate copolymers, ethylene-methyl-acrylate copolymers, ethylene-butyl-acrylate copolymers, ethylene-propylene-rubber, styrene butadiene rubber, ethylene-ethyl-acrylic copolymers, ionomers, polypropylenes, and copolymers of polypropylene and copolymerizabl ethylenically unsaturated commoners.

5. The method defined in claim 3, wherein said closed cell, foamed plastic polymer is further defined as comprising one or more polyethylenes selected from the group consisting of high density, medium density, low density, linear low density, ultra-high density, and medium low density.

6. The method defined in claim 1, wherein said forming step is further defined as comprising the steps of:
a. placing the mixture containing the anti-oxidant and the plastic material in an extruder;
b. extruding an elongated, substantially cylindrically shaped foamed plastic member; and
c. cutting the elongated plastic member in a plane substantially perpendicular to the central axis of the cylindrically shaped member, thereby establishing a plurality of thermoplastic closures having the desired length for insertion and retention in the neck of the container, with each closure having a controlled quantity of the anti-oxidant therein.

7. The method defined in claim 6, wherein said extrusion step is further defined as being carried out using a blowing agent.

8. The method defined in claim 7, wherein said extrusion process is further defined as incorporating one or more blowing agents selected from the group consisting of carbon dioxide, nitrogen, carbon, water, air nitrogen, helium, and argon, Azodicarbonamic Azodiisobutyro-Nitride, Benzenesulfonhydrazide, 4,4-Oxybenzene Sulfonylsemicarbazide, p-Toluene Sulfonylsemicarbazide, Barium Azodicarboxylate, N,N′-Dimethyl-N,N′-Dinitrosoterephthalamide, Trihydrazinotriazine, Aliphatic Hydrocarbons having 1-9 carbon atoms, Halogenated Aliphatic Hydrocarbons having 1-9 carbon atoms, Aliphatic Hydrocarbons having 1-9 atoms, Aliphatic alcohols having 1-3 carbon atoms and partially Hydrogenated Chlorocarbon and Chlorofluorocarbons.

9. The method defined in claimed 8, wherein said blowing agent is further defined as comprising between about 0.005% and 10% by weight based upon the weight of the entire mixture and comprising an inert blowing agent selected from the group consisting of nitrogen, carbon dioxide, water, air, nitrogen, helium, and argon.

10. The method defined in claim 2,wherein said synthetic closure is further defined as being formed by employing one method selected from the group consisting of molding and extrusion.

11. A method for manufacturing thermoplastic closures for use in sealing fluid products in a container having a portal formed in the neck of the container, said method comprising the steps of:
A. selecting at least one thermoplastic polymer as the material for the closure;
B. intermixing an antioxidant with the selected thermoplastic polymer to form a substantially homogeneous mixture;
C. controlling the amount of the antioxidant intermixed with the thermoplastic polymer to comprise no greater than 0.28% by weight based upon the weight of the entire mixture;
D. feeding the combined antioxidant and thermoplastic polymer mixture into an extruder;
E. extruding an elongated, substantially cylindrically shaped, foamed plastic member from the extruder; and
F. cutting the elongated, substantially cylindrically shaped, foamed plastic member in a plane substantially perpendicular to the central axis thereof,
thereby achieving a plurality of a separate and independent thermoplastic closures each having the desired length for insertion and retention in the portal of the neck of the container while also comprising a controlled quantity of the antioxidant for assuring removal of the closure from the container without requiring excessive force.

12. A stopper or closure for a product retaining container constructed for being inserted and securely retained in a portal forming neck of the container, said stopper/closure comprising:
A. an elongated, cylindrically shaped member formed from thermoplastic material, and
B. no greater than 0.28% by weight based upon the weight of the entire mixture of an anti-oxidant intermixed with the thermoplastic material;
whereby a stopper/closure is achieved which is removable from the portal forming neck of the container whenever desired by the user without requiring excessive force.

13. The stopper/closure defined in claim 12, wherein said stopper/closure is formed by one method selected from the group consisting of extrusion and molding.

14. The stopper/closure defined in claim 12, wherein said thermoplastic material is further defined as comprising at least one polymer selected from the group consisting of polyethyles, metal locene catalyst polyethyles, polybutanes, polybutylenes, polyurethanes, silicones, vinyl-based resins, thermoplastic elastomers, polyesters, ethylenic acrylic copolymers, ethylene-vinyl-acetate copolymers, ethylene-methyl-acrylate copolymers, ethylene-butyl-acrylate copolymers, ethylene-propylene-rubber, styrene butadiene rubber, ethylene-ethyl-acrylic copolymers, ionomers, polypropylenes, and copolymers of polypropylene and copolymerizable ethylenically unsaturated commoners.

15. A product by process, said product comprising a closure for retaining fluids in a container, constructed for being inserted and securely retained in a portal forming neck of the container and comprising:
A. an elongated, cylindrically shaped member formed from foamed thermoplastic material; and
B. an antioxidant intermixed with the thermoplastic material in a quantity which is not greater than 0.28% by weight based upon the weight of the entire mixture;
said closure being produced by a method comprising the steps of:
A. selecting at least one thermoplastic polymer as the material for the closure;
B. intermixing an antioxidant with the selected thermoplastic polymer to form a substantially homogeneous mixture;
C. controlling the amount of the antioxidant intermixed with the thermoplastic polymer to comprise no greater than 0.28% by weight based upon the weight of the entire mixture;
D. feeding the combined antioxidant and thermoplastic polymer mixture into an extruder;
E. extruding an elongated, substantially cylindrically shaped, foamed plastic member from the extruder; and
F. cutting the elongated, substantially cylindrically shaped, foamed plastic member in a plane substantially perpendicular to the central axis thereof,
thereby achieving a plurality of separate and independent thermoplastic closures each having the desired length for insertion and retention in the portal of the neck of the container while also comprising a controlled quantity of the antioxidant for assuring removal of the closure from that the container without requiring excessive force.
